(19) United States
(12) Patent Application Publication
(10) Pub. No.: US 2009/0144686 A1
(43) Pub. Date: Jun. 4, 2009

(54) METHOD AND APPARATUS FOR MONITORING MARGINAL LAYOUT DESIGN RULES

(76) Inventors: KEVIN R. LENSING, Austin, TX (US); Jason P. Cain, Austin, TX (US); Bhanwar Singh, Morgan Hill, CA (US); Luigi Capodieci, Santa Cruz, CA (US); Cyrus E. Tabery, San Jose, CA (US)

Correspondence Address: Scott F. Diring;WILLIAMS, MORGAN & AMERSON, P.C., Suite 1100, 10333 Richmond Drive, Houston, TX, 77042, US

(21) Appl. No.: 11/948,218

(22) Filed: Nov. 30, 2007

(51) Int. Cl. G06F 19/00

(52) U.S. Cl. 716/10

(57) ABSTRACT

A method includes generating a layout for an integrated circuit device in accordance with a plurality of layout design rules. A plurality of metrology sites on the layout associated with at least one subset of the layout design rules is identified. A metrology tag associated with each of the metrology sites is generated. At least one metrology recipe for determining a characteristic of the integrated circuit device is generated based on the metrology tags. Metrology data is collected using the at least one metrology recipe. A selected layout design rule in the at least one subset is modified based on the metrology data.

### CROSS-REFERENCE TO RELATED APPLICATIONS

Not applicable.

### BACKGROUND OF THE INVENTION

The disclosed subject matter relates generally to manufacturing and, more particularly, to a method and apparatus for monitoring marginal layout design rules.

In designing an integrated circuit (IC) device, engineers or designers typically rely on computer design tools to help create an IC schematic or design, which can include a multitude of individual devices, such as transistors, coupled together to perform a certain function. To actually fabricate the IC device in or on a semiconductor substrate, the IC device schematic must be translated into a physical representation or layout, which itself can be transferred onto the surface of the semiconductor substrate. Computer-aided design (CAD) tools can be used to assist layout designers with translating the discrete circuit elements into shapes, which will embody the devices themselves in the completed IC device. These shapes make up the individual components of the circuit, such as gate electrodes, diffusion regions, metal interconnects and the like.

The software programs employed by the CAD systems to produce layout representations are typically structured to function under a set of predetermined layout design rules in order to produce a functional circuit. Often, the layout design rules are determined by certain processing and design limitations based roughly on the patternability of layout designs. For example, layout design rules may define the space tolerance between devices or interconnect lines. Layout design rules are different than process control design rules that provide constraints or specifications for manufacturing processes. For example, in a process control situation upper or lower bounds for a process parameter or feature characteristic may be provided. These process control design rules relate to keeping process controllers from adjusting parameters without limits. Layout design rules relate to the spacing rules that designers must follow in designing the device.

Once the layout of the circuit has been created, the next step to manufacturing the IC device is to transfer the layout onto a semiconductor substrate. For instance, patterns can be formed from a photoresist layer disposed on the wafer by passing light energy through a mask having an arrangement to image the desired pattern onto the photoresist layer. As a result, the pattern is transferred to the photoresist layer. In areas where the photoresist is sufficiently exposed, and after a development cycle, the photoresist material becomes soluble such that it can be removed to selectively expose an underlying layer (e.g., a semiconductor layer, a metal or metal containing layer, a dielectric layer, a hard mask layer, etc.). Portions of the photoresist layer not exposed to a threshold amount of light energy will not be removed and serve to protect the underlying layer during further processing of the wafer (e.g., etching exposed portions of the underlying layer, implanting ions into the wafer, etc.). Thereafter, the remaining portions of the photoresist layer can be removed.

There is a pervasive trend in the art of IC fabrication to increase the density with which various structures are arranged. For example, feature size, line width, and the separation between features and lines are becoming increasingly smaller. In these sub-micron processes, yield is affected by factors such as mask pattern fidelity, optical proximity effects and photoresist processing. Some of the more prevalent concerns include line end pullback, corner rounding and line-width variations. These concerns are largely dependent on local pattern density and topology.

Optical proximity correction (OPC) has been used to improve image fidelity. In general, current OPC techniques involve running a computer simulation that takes an initial data set having information relating to the desired pattern and manipulates the data set to arrive at a corrected data set in an attempt to compensate for the above-mentioned concerns. A photomask can then be made in accordance with the corrected data set. Briefly, the OPC process can be governed by a set of geometrical rules (i.e., “rule-based OPC” employing fixed rules for geometric manipulation of the data set), a set of modeling principles (i.e., “model-based OPC” employing predetermined behavior data to drive geometric manipulation of the data set), or a hybrid combination of rule-based OPC and model-based OPC. Hence, additional layout design rules are typically imposed by the OPC process.

The process of generating an OPC model is time intensive and expensive. Techniques for evaluating OPC models involve intensively manual processes that are time consuming and prone to errors and/or omissions. Briefly, verifying OPC models involve hand checking the layout corrections made to a test pattern to verify that the OPC routine applying the OPC model performs in an expected manner. Typically, OPC model building and validation is a one-time event that occurs well before products reach manufacturing. The model is validated based on test patterns when the process transfers to manufacturing, but it is typically not re-examined thereafter. It is not often feasible to test all layout design rules in the test patterns due to time and cost constraints. Hence, the determination of some layout design rules involves a degree of estimation on the part of the designers, i.e., a best guess. Layout design rules are typically static once a design goes into production, unless a yield issue is identified. The process of tracing a yield issue to a particular layout design rule is difficult.

Once a wafer of IC devices is manufactured, experimental testing and/or inspection of the manufactured devices can be performed to verify that the manufactured devices are within specification limits set by the device design and/or layout. This testing, which is commonly referred to as metrology, can include obtaining critical dimension (CD) measurements of structures across the device (e.g., scanning electron microscopy (SEM) images) as well as other optical and electrical measurements.

Currently, there is no convenient way to assign errors detected during metrology (wafer metrology or reticle metrology) to a specific location within the layout. For example, an SEM image may show a defect within a structure on the patterned wafer. However, the corresponding location within the layout cannot be determined without considerable time and expense. Further, there is no coordination of locations across the various spaces involved in IC device design, manufacture and testing (i.e., circuit design, circuit layout, reticle manufacture, and wafer patterning). Therefore, when an error is detected during metrology, there is no practical way to trace it across the different spaces involved in IC device design and manufacture.

Moreover, metrology recipes may be designated manually by production personnel after a design has been completed. The metrology sites are not necessarily tied back to design features. Hence, although the metrology recipes may collect data to enable process control, the metrology data does not necessarily provide information useful in characterizing or improving the design process. The large numbers of products and layers per product running in a fabrication facility result in a recipe creation process that is time consuming, both in terms of engineering time and tool time. In addition, the manual process for creating such a large number of recipes is prone to human error and inconsistencies between recipes.

More recently, tools have become available to automate a large portion of the recipe generation process, for example, a variety of different applications have been developed by metrology tool suppliers or fabrication companies to generate recipes based on simple input files and design information. These applications have been given a variety of names, including Design-Based Metrology (DBM) and Automatic Recipe Creation (ARC). However, the complexity of this system necessary to give it the flexibility required to execute arbitrary metrology requests means that a significant level of training is needed in order to reach a level of expertise sufficient to use the system as intended. Given that the metrology sites used for inline measurements are typically decided during the design phase, such flexibility and complexity is not needed to generate recipes for these sites.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF THE INVENTION

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that includes generating a layout for an integrated circuit device in accordance with a plurality of layout design rules. A plurality of metrology sites on the layout associated with at least one subset of the layout design rules is identified. A metrology tag associated with each of the metrology sites is generated. At least one metrology recipe for determining a characteristic of the integrated circuit device is generated based on the metrology tags. Metrology data is collected using the at least one metrology recipe. A selected layout design rule in the at least one subset is modified based on the metrology data.

Another aspect of the disclosed subject matter is seen in a system including a data store, a metrology tag unit, at least one metrology tool, and a design rule unit. The data store is operable to store a plurality of metrology tags. Each metrology tag is associated with a metrology site on a layout for an integrated circuit device. The metrology sites are associated with at least one subset of the plurality of design rules associated with the layout. The metrology tag unit is operable to access at least a subset of the metrology tags and generate at least one metrology recipe for measuring characteristics of the integrated circuit device based on the subset of metrology tags. The metrology tool is operable to execute the at least one metrology recipe to generate metrology data. The design rule unit is operable to generate a recommendation for modifying a selected layout design rule in the at least one subset based on the metrology data.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified block diagram of a manufacturing system;

FIG. 2 is a simplified device layout diagram;

FIG. 3 is a diagram of an exemplary data structure for a metrology tag employed in the system of FIG. 1;

FIG. 4 is a simplified flow diagram illustrating the automatic creation of metrology recipes using the metrology tags of FIG. 3; and

FIG. 5 is a simplified flow diagram illustrating the manual creation of metrology recipes using the metrology tags of FIG. 3.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION OF THE INVENTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

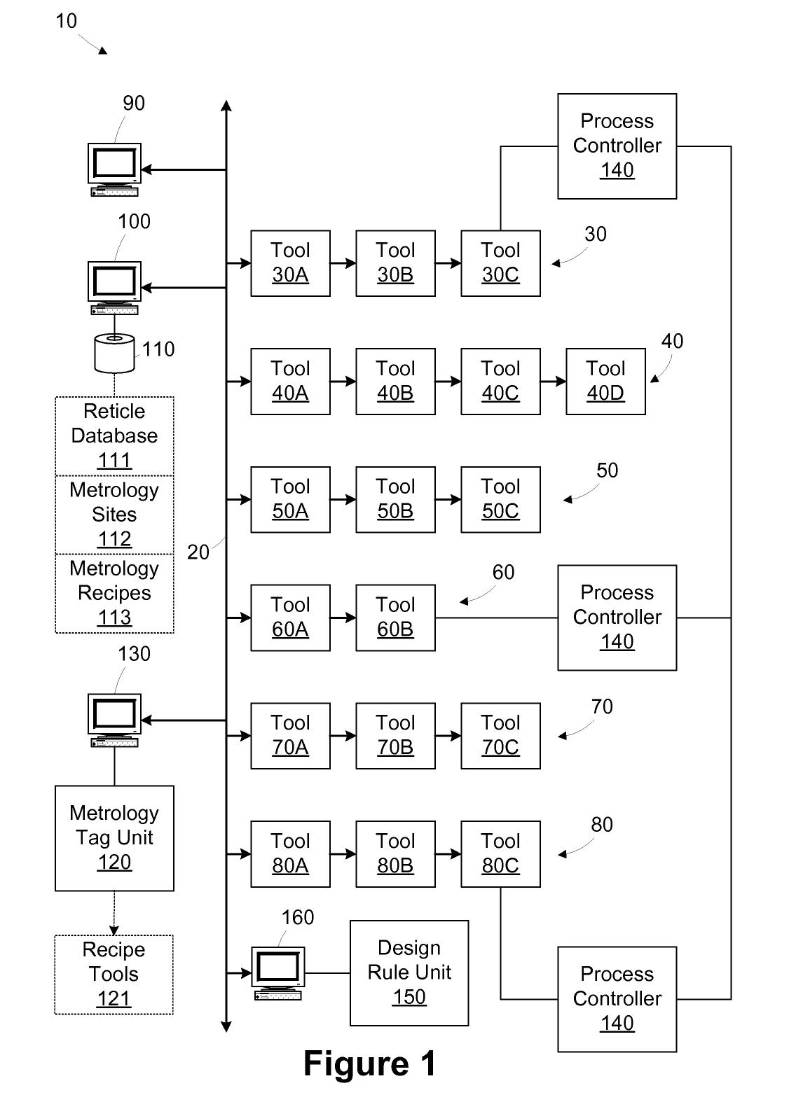

Referring now to the drawings wherein like reference numbers correspond to similar components throughout the several views and, specifically, referring to FIG. 1, the disclosed subject matter shall be described in the context of a simplified block diagram of an illustrative manufacturing system 10. The manufacturing system 10 includes a network 20, a plurality of tools 30-80, a manufacturing execution system (MES) server 90, a database server 100 and its associated data store 110, a metrology tag unit 120 executing on a workstation 130, one or more process controllers 140, and a design rule unit 150 operating on a workstation 160. As will be described in greater detail below, the metrology tag unit 120 employs metrology tags generated during the design process to allow the generation of design feedback data, as well as to provide the ability to automate the metrology recipe generation process. In one embodiment, the metrology tag unit 120 is a general purpose computer including a processing unit and storage (e.g., hard disk, network drive, optical disk, etc.). Program instructions may be encoded on the storage medium to implement the functions described herein. The computer system may be centralized or distributed. For example, in a distributed system, the metrology tags may be stored in a different physical unit than the metrology tag unit 120, but the tags may be accessible (e.g., over a network or Internet connection).

In the illustrated embodiment, the manufacturing system 10 is adapted to fabricate semiconductor devices. Although the subject matter is described as it may be implemented in a semiconductor fabrication facility, it is not so limited and may be applied to other manufacturing environments. The techniques described herein may be applied to a variety of workpieces or manufactured items, including, but not limited to, microprocessors, memory devices, digital signal processors, application specific integrated circuits (ASICs), or other devices. The techniques may also be applied to workpieces or manufactured items other than semiconductor devices.

The network 20 interconnects various components of the manufacturing system 10, allowing them to exchange information. The illustrative manufacturing system 10 includes a plurality of tools 30-80. Each of the tools 30-80 may be coupled to a computer (not shown) for interfacing with the network 20. The tools 30-80 are grouped into sets of like tools, as denoted by lettered suffixes. For example, the set of tools 30A-30C represent tools of a certain type, such as a chemical mechanical planarization tool. A particular wafer or lot of wafers progresses through the tools 30-80 as it is being manufactured, with each tool 30-80 performing a specific function in the process flow. Exemplary processing tools for a semiconductor device fabrication environment include metrology tools, photolithography steppers, etch tools, deposition tools, polishing tools, rapid thermal processing tools, implantation tools, etc. The tools 30-80 are illustrated in a rank and file grouping for illustrative purposes only. In an actual implementation, the tools 30-80 may be arranged in any physical order or grouping. Additionally, the connections between the tools in a particular grouping are meant to represent connections to the network 20, rather than interconnections between the tools 30-80.

The manufacturing execution system (MES) server 90 directs the high level operation of the manufacturing system 10. The MES server 90 monitors the status of the various entities in the manufacturing system 10 (i.e., lots, tools 30-80) and controls the flow of articles of manufacture (e.g., lots of semiconductor wafers) through the various tools. The database server 100 stores data related to the status of the various entities and articles of manufacture in the process flow. The database server 100 may store information in one or more data stores 110. The data may include pre-process and post-process metrology data, tool states, lot priorities, etc.

Process controllers 140 may be associated with one or more of the process tools 30-80. The process controllers 140 determine control actions for controlling selected ones of the tools 30-80 serving as process tools based on metrology data collected during the fabrication of wafers (i.e., by others of the tools 30-80 serving as metrology tools). The particular control models used by the process controllers 140 depend on the type of tool 30-80 being controlled. The control models may be developed empirically using commonly known linear or non-linear techniques. The control models may be relatively simple equation-based models (e.g., linear, exponential, weighted average, etc.) or a more complex model, such as a neural network model, principal component analysis (PCA) model, partial least squares projection to latent structures (PLS) model. The specific implementation of the control models may vary depending on the modeling techniques selected and the process being controlled. The selection and development of the particular control models would be within the ability of one of ordinary skill in the art, and accordingly, the control models are not described in greater detail herein for clarity and to avoid obscuring the present subject matter.

The processing and data storage functions are distributed amongst the different computers in FIG. 1 to provide general independence and central information storage. Of course, different numbers of computers and different arrangements may be used without departing from the spirit and scope of the present subject matter.

Portions of the present subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

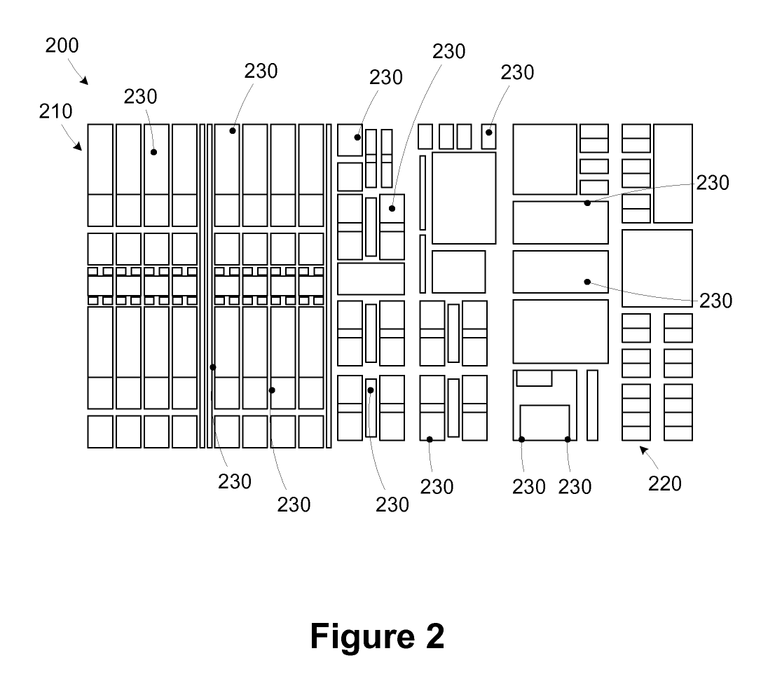

Turning now to FIG. 2, a simplified layout diagram 200 of a device is shown. The layout diagram 200 is simplified in that it represents a composite view of the layout. An actual design layout will include multiple layers. Typically, a layout includes memory modules 210 and logic modules 220. The application of the present subject matter is not limited to any particular device topology or specific modules. Each module 210, 220 is made up of various features, such as transistors, lines, contacts, vias, etc., that cooperate to provide the functionality of the module 210, 220.

Prior to the device entering production, designers or engineers may designate certain locations as metrology sites 230. These sites 230 may correspond to design features identified as being significant contributors to device performance or yield, features associated with targeted layout design rules, features associated with optical proximity correction verification, process control metrology sites, fault detection sites or areas. The sites 230 may be located within the functional area of the device or on a scribe line regions disposed between two adjacent devices. In the case of scribe line features, the sites 230 may correspond to test fixtures, such as, but not limited to tuning forks, ring oscillators, scatterometry gratings, process characterization structures, or structures for global alignment.

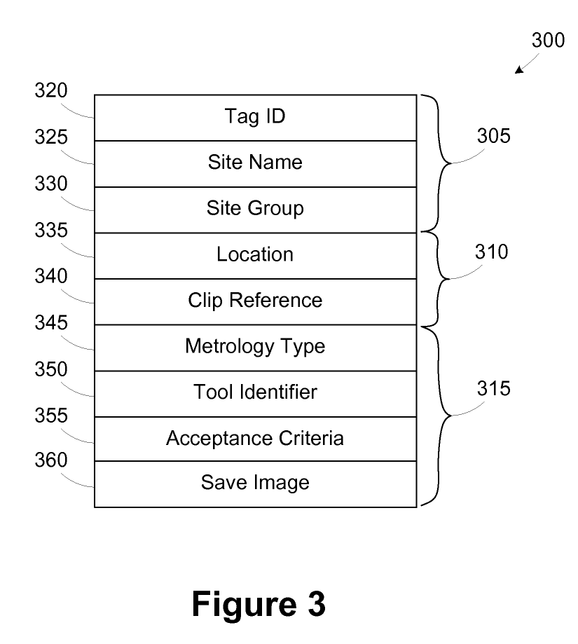

To facilitate later metrology recipe creation, each designated site 230 is assigned a metrology tag 300, as illustrated in FIG. 3. Generally, the metrology tag 300 includes identification data 305 that identifies the metrology site 230, location data 310 that indicates the position of the site 230 on the device layout, and metrology context data 315 useful for determining the purpose of the metrology site 230.

The identification data 305 includes a Tag ID field 320 that specifies a unique ID for the site 230, a Site Name field 325, and a Site Group field 330. The Tag ID field 320 and Site Name field 325 cooperate to uniquely identify the site 230. In some embodiments, these fields 320, 325 may be combined into a single unique identifier depending on the particular naming convention selected. The Site Group field 330 assigns a unique identifier to a group of sites with a similar purpose. For example, sites 230 associated with the measurement of a particular parameter at different locations may be assigned different identifiers, but a common group identifier so that their common relationship may be identified during recipe generation. For example, a Site Group field 330 may be used to designate a common layer or to designate a group of sites selected for determining across wafer uniformity. Sites 230 may belong to multiple site groups.

The location data 310 includes a Location field 335 that specifies the metrology site location using a standard coordinate system. The coordinates are generally centered on the metrology site 230. An exemplary universal coordinate system (UCS) is described in U.S. patent application Ser. No. 11/539,788 entitled “Method and Apparatus for Implementing a Universal Coordinate System for Metrology Data,” assigned to the same assignee as the present application, and incorporated herein by reference in its entirety.

The location data 310 may also include a Clipped Layout field 340 that identifies a clipped layout data file that represents an optical image of the portion of the design where the metrology site 230 is disposed. As is known in the art clipped layout data may be used by various metrology tools to align the tool for measurement purposes. Generally, the metrology tool uses the clipped layout image as an overlay for optically aligning the device being measured. An exemplary technique for generating clipped layout data files from regions of interest is shown in U.S. Pat. No. 7,207,017, entitled, “Method and system for Metrology Recipe Generation and Review and Analysis of Design, Simulation, and Metrology Results”, assigned to the same assignee as the present application, and incorporated herein by reference in its entirety. In one embodiment, the Clipped Layout field 340 may provide a reference to an external data file (e.g., stored elsewhere in the data store 110). In another embodiment, the clipped layout data may be stored in the same data structure as the tag 300.

The metrology context data 315 includes data that specifies the significance of the metrology site 230. The metrology context data 315 includes a Metrology Type field 345 that designates the type of metrology data being collected. Exemplary, but not exhaustive, metrology types includes overlay, OPC, electrical, critical dimension scanning electron microscope (CD-SEM), film thickness, scatterometry, atomic force microscope, etc. The Metrology Type field 345 generally identifies the type of tool used to collect metrology data from the site 230. A Tool Identifier field 350 (optional) may also be provided to indicate a specific metrology (i.e., by a particular tool vendor). The metrology context data 315 also may include an Acceptance Criteria field 355 (optional) that specifies the target or expected value for the feature to be measured at the metrology site 230 (e.g., film thickness, CD, pitch, spacing, etc.). A Save Image field may be provided to specify whether an image from the metrology site 230 should be automatically saved during the metrology event.

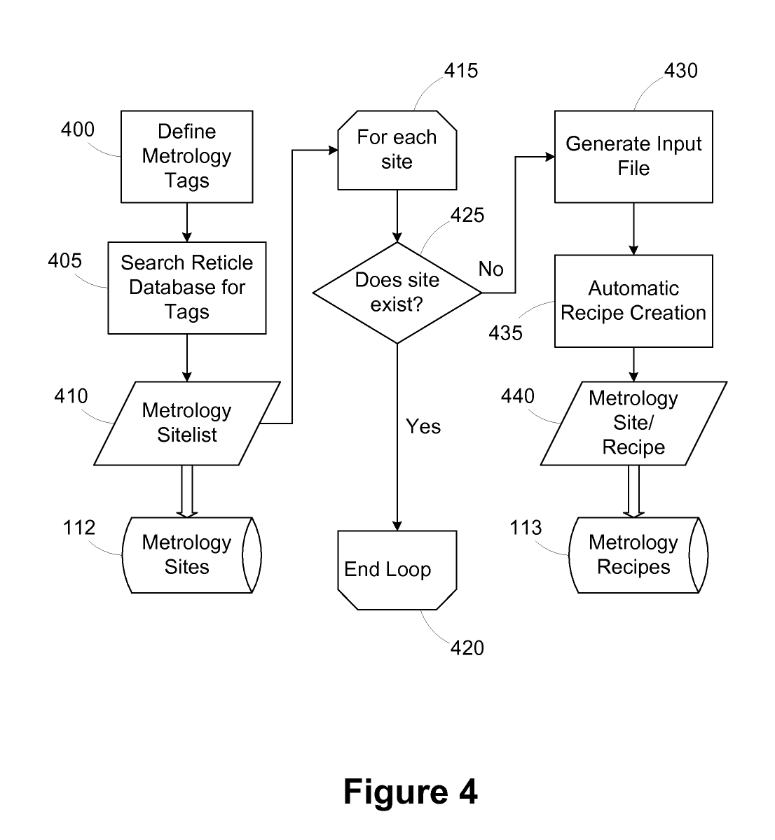

The use of metrology tags 300 is now described with reference to the simplified flow diagram illustrated in FIG. 4. In method block 400, metrology tags 300 may be defined for specific locations during the design process. The metrology tags 300 may be stored in a reticle database 111 in the data store 110 (see FIG. 1). At tape out, the metrology tag unit 120 searches the reticle database 111 for metrology tags 300 in method block 405 and generates a sitelist 410 from the tags 300. The sitelist 410 for the indicated metrology sites 230, including corresponding product and layer information, is stored in a metrology site database 112. FIG. 4 illustrates a single loop for one recipe. For example, one recipe may be generated based on a common value for the Site Group field 330. Additionally, an outer loop may be defined to generate all recipes for a given product. Hence, multiple recipes may be generated using multiple iterations of the method to automate the recipe production for a product.

In method blocks 415 and 420 a loop is executed for each site. If the site exists in method block 425, the sitelist 410 and corresponding tags 300 may be used by the metrology tag unit 120 to generate an input file (e.g., text/XML and layout clips if needed) for a recipe generation tool 121 for the metrology tool in method block 430. In one embodiment, recipe tools 121 may be developed for each type of metrology tool employed in the manufacturing system 10. In another embodiment, vendor supplied recipe tools 121 may be employed. For example, tool suppliers, such as Applied Materials, Inc, Hitachi High-Technologies Corp (CD-SEM), Nanometrics, Inc. (overlay), and KLA-Tencor Corp. (overlay and scatterometry) provide automated recipe generation tools 121. The appropriate input file format and associated recipe tool 121 may be determined based on the Metrology Type field 345 and/or the Tool Identifier field 350 of the metrology tag 300.

In method block 435, an automatic recipe generation tool 121 is invoked using the input file generated in method block 430. In cases where tools from multiple tool suppliers are used, input files could be generated for all tool suppliers or rules could be defined to assign certain product/layer combinations to the corresponding supplier. The resulting metrology recipes 440 are stored in a metrology recipe database 113 and/or distributed to the individual metrology tools 30-80 through the network 20.

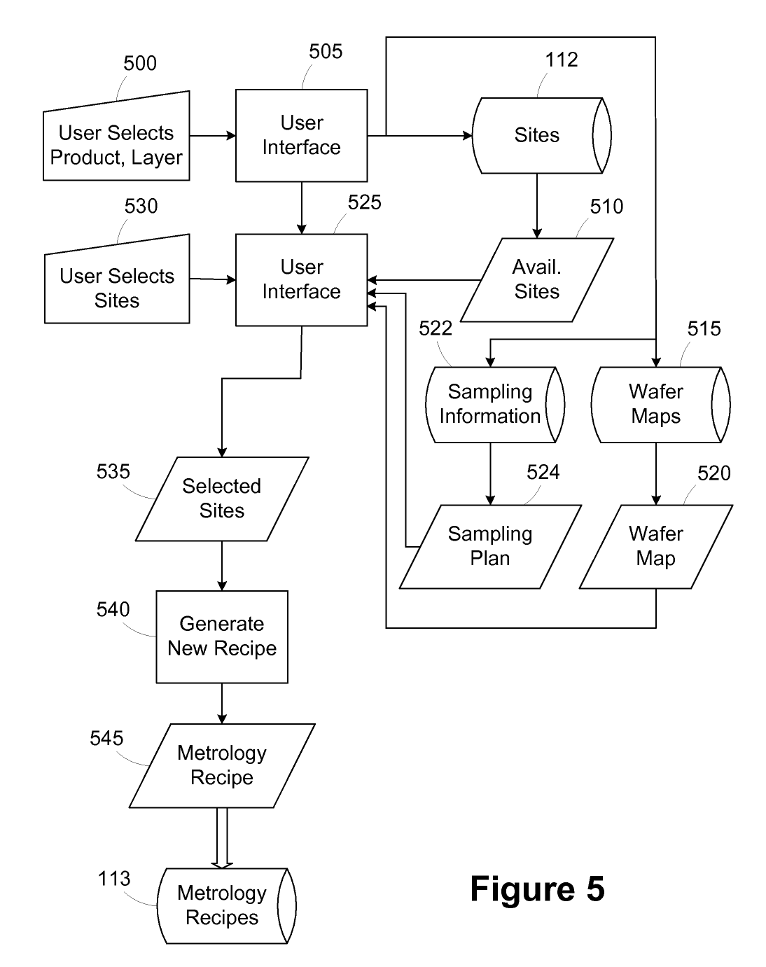

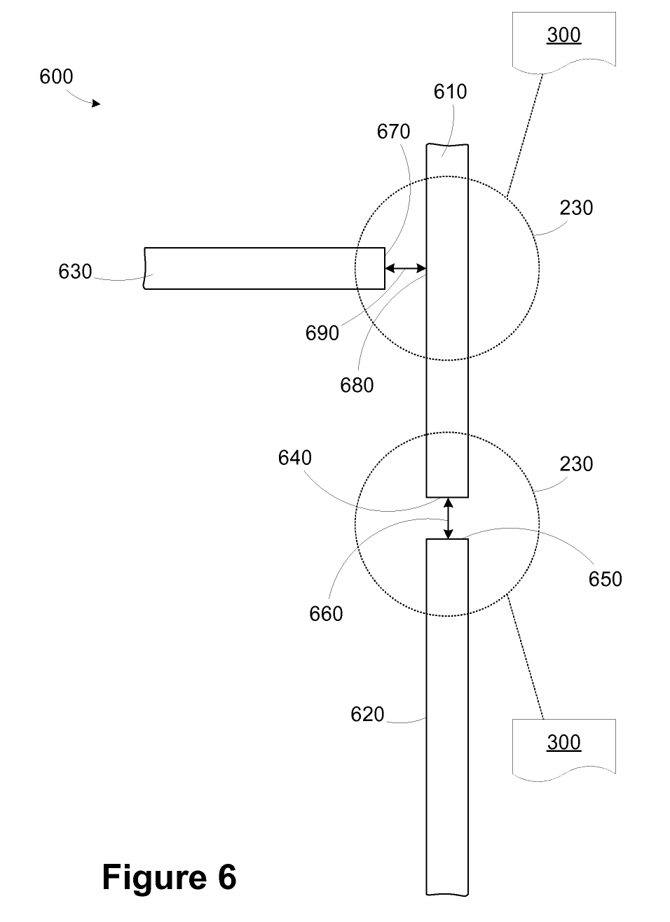

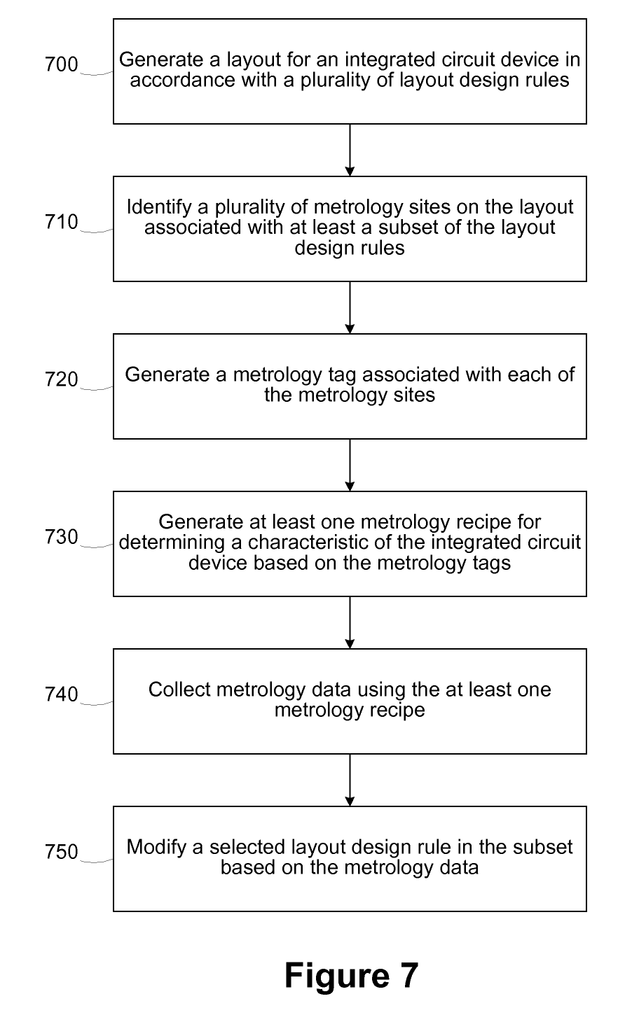

In cases where a particular tool supplier does not provide an automated recipe tool 121, or a general recipe tool 121 has not been created, a user may also use an automated interface that considers the metrology tags 300 and allows the user to specify recipes for a particular product and layer. A simplified flow diagram for generating a metrology recipe is described below in reference to FIG. 5.

In method block 500, a user selects a particular product and layer for which a recipe is to be generated. To facilitate the selection, a user interface 505 may be employed. In one embodiment, the user interface 505 may be implemented using a web browser application that includes a variety of input controls and includes program and database instructions for accessing various data sources described below. The user interface 505 accesses the metrology site database 112 to identify the available sites 510 (i.e., having associated metrology tags 300) that have been identified for the specified product and layer. The user interface 505 may also access a wafer map database 515 to retrieve a wafer map 520 that identifies the layout of devices on a wafer and a sampling information database 522 that specifies a sampling plan 524 at the lot, wafer, and/or site level. The sites specified in the metrology site database 112 identify the tagged locations on a particular device, and the wafer map identifies the pattern at which the sites are repeated over the wafer. The sampling plan specifies the spatial distribution of the measurement sites within a die, wafer, or lot.

The user interacts with a second user interface 525 (e.g., a subsequent screen of the interface application) that receives and displays the available sites 510, wafer maps 520, and sampling plans 524. In method block 530, the user selects those sites and sampling plans to be included in the metrology recipe. The user may specify one or more filters to limit the available sites. For example, the user may specify a particular metrology type, tool supplies, or site group. The data specified in the metrology tags 300 may then be used to filter the sites to display only those meeting the user's criteria. Based on the user's selection, the user interface 525 outputs the selected sites 535. In method block 540 a metrology recipe 545 is generated responsive to the selected sites 535 and/or the wafer map 520. The metrology recipe 545 is stored in the metrology recipe database 113 and/or distributed to the individual metrology tools 30-80.

The metrology tags 300 facilitate automatic or reduced complexity manual recipe generation. The purpose of the metrology sites can be captured early in the process, well before actual production commences. In this manner, the metrology sites may be associated with design features to allow better characterization of the product life cycle, beginning with device design, layout, optical proximity correction, reticle fabrication, and fabrication.

In one particular embodiment, metrology tags 300 are defined for locations that correspond to marginal design rules. A design rule manual for an actual semiconductor design typically includes hundreds of pages that specify thousands of design rules. Many rules are complicated and include conditional features. Exemplary design rules include minimum polysilicon line pitch, maximum untiled active area, minimum tip-to-tip line distance, minimum tip-side distance, minimum contact to poly spacing, etc. Some conditional rules apply only when certain other features are located near the feature for which the rule is imposed.

During layout design rule verification, various test patterns are used to determine limits for the specifications of feature critical dimensions (CD). Generally, in a high volume manufacturable process, the CD variability of the patterned features is within acceptable tolerances (e.g., ±5%). Due to process variability a pattern failure (e.g., bridging) may occur, or the CD variation may consistently exceed the acceptable tolerances. There is a region in between the CD in-specification region and the out-of-specification regions where the feature just barely meets the specification. Layout design rules associated with such barely passing regions are commonly referred to as being marginal layout design rules. The layout design rule is marginal because it is barely passing, or almost failing. The term marginal indicates a design rule that is at the limit of the specification tolerance for a given process. When a device layout is completed, sites 230 corresponding to marginal layout design rules may be identified using automated software analysis (e.g., by the design rule unit 150 of FIG. 1) or designer input. For example, sites 230 where the device layout is within 5% or less of the marginal layout design rule may be flagged as target sites 230 for layout design rule verification. The same software that is used to verify a device layout with respect to the layout design rules may be adapted to flag those sites that approach the layout design rule limits. Of course, the particular value of the threshold used for flagging the sites may vary depending on the particular implementation.

FIG. 6 illustrates a portion of an exemplary semiconductor device 600 including a plurality of lines 610, 620, 630. The semiconductor device 600 is greatly reduced in complexity and scope to facilitate an illustration of exemplary simple layout design rules. The lines 610, 620 are arranged such that the tip 640 of the line 610 is proximate the tip 650 of the line 620, and the tip-to-tip spacing is represented by the dimension 660. The line 630 is perpendicular to the line 610, such that a tip 670 of line 630 is proximate a side 680 of the line 610. The tip-to-side spacing is represented by the dimension 690. The tip-to-tip dimension 660 and the tip-to-side dimension 690 may be the subject of layout design rules. Assuming for purposes of illustration, that these dimension rules were considered marginal design rules, metrology sites 230 may be specified that reference these locations in the layout through the generation of associated metrology tags 300. Of course in an actual implementation, the marginal layout design rules could be more complicated than the simple layout design rules illustrated here. Those of ordinary skill in the art are capable of specifying layout design rules and identifying those that are marginal.

The layout design rule sites 230 may be located within the functional region of the device, or specific test structures may be constructed in the scribe line regions to test the marginal layout design rule limits. The tags 300 associated with designated layout design rules may be designated using the Site Group fields 330, and/or metrology type fields 345 shown in FIG. 3. Metrology recipes may be generated automatically as described above in reference to FIGS. 4 and 5 for the layout design rule sites 230.

Subsequently, metrology data may be collected during production using the designated sites 230, as facilitated by the metrology tags 300. The metrology data may include pattern data, defect data, dimension data, etc. The metrology data may be used by the design rule unit 150 to identify pattern-related or electrical issues arising at the designated sites 230. For example, the design rule unit 150 may correlate the layout metrology data with electrical performance data, such as grade or yield, to determine if variations in the dimensions corresponding to the layout design rule impact the device performance.

By tracking marginal design rules using metrology tags 300, the design rule unit 150 may generate feedback to guide designers regarding current or future products. Based on these relationships, the layout design rules may be relaxed or tightened for a subsequent design or design revision. For example, if the metrology data indicates that variation at the sites 230 has a significant negative effect on performance or pattern defects, the layout design rule limit may be strengthened (e.g., minimum distance increased). Contrastingly, if the metrology data indicates that the variation does not have any significant impact, the design rule may be relaxed (e.g., minimum distance decreased). In the case of relaxing a design rule, it may be warranted to include the layout design rule in future test patterns for a new or revised device to better determine if the design rule may be relaxed. The Clipped Layout field 340 of the metrology tag 300 may be used to provide a reference pattern to be compared to the measured pattern to identify pattern defects.

Multiple sites 230 may be designated on a particular device layout to test each layout design rule. In this manner, it may be possible to impose or modify conditional features of the layout design rule. For example, if a particular spacing is identified as causing problem at some sites, but other sites with the same spacing do not exhibit similar problems, the other features proximate the site may be analyzed. The layout design rule may be strengthened when the other features are present, but not when the features are absent using a conditional rule for applying the more stringent spacing.

FIG. 7 is a simplified flow diagram of a method for monitoring layout design rules. In method block 700, a layout is generated for an integrated circuit device in accordance with a plurality of layout design rules. In method block 710, a plurality of metrology sites on the layout associated with at least a subset of the layout design rules is identified. In method block 720, a metrology tag associated with each of the metrology sites is generated. In method block 730, at least one metrology recipe is generated for determining a characteristic of the integrated circuit device based on the metrology tags. In method block 740, metrology data is collected using the at least one metrology recipe. In method block 750, a selected layout design rule in the subset is modified based on the metrology data.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
generating a layout for an integrated circuit device in accordance with a plurality of layout design rules;
identifying a plurality of metrology sites on the layout associated with at least one subset of the layout design rules;
generating a metrology tag associated with each of the metrology sites;
generating at least one metrology recipe for determining a characteristic of the integrated circuit device based on the metrology tags;
collecting metrology data using the at least one metrology recipe; and
modifying a selected layout design rule in the at least one subset based on the metrology data.

2. The method of claim 1, wherein identifying the plurality of metrology sites further comprises identifying metrology sites having layout characteristics within predetermined limits associated with the plurality of layout design rules.

3. The method of claim 1, wherein collecting the metrology data comprises collecting dimension data.

4. The method of claim 3, further comprising identifying pattern defect information based on the dimension data.

5. The method of claim 4, wherein the selected layout design rule includes a spacing parameter, and modifying the selected layout design rule comprises increasing the spacing parameter based on the pattern defect information.

6. The method of claim 3, wherein collecting the metrology data comprises collecting electrical performance data, and the method further comprises:
correlating the electrical performance data with the dimension data; and
modifying a limit associated with the selected layout design rule based on the correlation.

7. The method of claim 1, further comprising:
defining at least one feature in a scribe line region of the layout to test at least one of the layout design rules; and
specifying at least one of the plurality of metrology sites to reference the feature.

8. The method of claim 1, wherein at least a portion of the plurality of metrology sites identified on the layout are disposed in a functional region of the integrated circuit device.

9. The method of claim 1, wherein each metrology tag includes identification data, location data, and metrology context data relating to the associated metrology site.

10. The method of claim 9, wherein the location data comprises clip reference data providing an image of a portion of the layout proximate the associated metrology site.

11. The method of claim 9, wherein the metrology context data comprises metrology type data.

12. The method of claim 9, wherein the metrology context data comprises a metrology tool identifier.

13. The method of claim 12, further comprising:
selecting a recipe generation tool based on the metrology tool identifier; and
executing the selected recipe generation tool to generate the at least one metrology recipe.

14. The method of claim 1, further comprising:
identifying a subset of the metrology sites as being available sites based on the metrology tags;
receiving user input selecting a subset of the available sites; and
generating the at least one metrology recipe responsive to the user selected subset of the available sites.

15. The method of claim 14, further comprising:
receiving sampling plan information; and
generating the at least one metrology recipe based on the sampling plan and the user input.

16. A system, comprising:
a data store operable to store a plurality of metrology tags, each metrology tag being associated with a metrology site on a layout for an integrated circuit device, the metrology sites being associated with a least one subset of the plurality of design rules associated with the layout;
a metrology tag unit operable to access at least a subset of the metrology tags and generate at least one metrology recipe for measuring characteristics of the integrated circuit device based on the subset of metrology tags;
at least one metrology tool operable to execute the at least one metrology recipe to generate metrology data; and
a design rule unit operable to generate a recommendation for modifying a selected layout design rule in the at least one subset based on the metrology data.

17. The system of claim 16, wherein the design rule unit is operable to link the measured data to the associated metrology tags.

18. The system of claim 16, wherein each metrology tag includes identification data, location data, and metrology context data relating to the associated metrology site.

19. The system of claim 18, wherein the location data comprises clip reference data providing an image of a portion of the layout proximate the associated metrology site.

20. The system of claim 16, wherein the plurality of metrology sites have layout characteristics within predetermined limits associated with the plurality of layout design rules.

21. The system of claim 16, wherein the metrology data comprises dimension data.

22. The system of claim 21, wherein the selected layout design rule includes a spacing parameter, and the design rule unit is operable to identify pattern defect information based on the dimension data recommend modify the spacing parameter based on the pattern defect information.

23. The system of claim 21, wherein the metrology data further comprises electrical performance data, and the design rule unit is operable to correlate the electrical performance data with the dimension data and recommend modifying a limit associated with the selected layout design rule based on the correlation.

24. The system of claim 16, wherein each metrology tag includes identification data, location data, and metrology context data relating to the associated metrology site.

25. The system of claim 24, wherein the location data comprises clip reference data providing an image of a portion of the layout proximate the associated metrology site.
